(19) United States
(12) Patent Application Publication
(10) Pub. No.: US 2008/0216953 A1
(43) Pub. Date: Sep. 11, 2008

(54) ENHANCED DEVICE FOR MAKING A MULTILAYER PART COMPRISING AN ASPECT LAYER WITH A GRANULATED SURFACE

(75) Inventor: Christophe Tirlemont, Le Poinconnet (FR)

Correspondence Address: LEYDIG VOIT & MAYER, LTD, 700 THIRTEENTH ST. NW, SUITE 300, WASHINGTON, DC, 20005-3960, US

(73) Assignee: MOLLERTECH SAS, Verrieres le Buisson (FR)

(21) Appl. No.: 11/849,457

(22) Filed: Sep. 4, 2007

(30) Foreign Application Priority Data
Sep. 4, 2006 (FR) 06 53 566

(51) Int. Cl. B29C 65/42

(52) U.S. Cl. 156/285; 425/112

(57) ABSTRACT

A device for making a multilayer part including an aspect layer with a granulated surface. Suction ports open out on a portion of a molding surface of an imprint with a shape complementary to a portion of the aspect layer, such as a peripheral portion.

### FIELD OF THE INVENTION

The present invention relates to a device for making a multilayer part provided with a stiff supporting layer and an aspect layer provided with decorations in relief such as granules, attached on the supporting layer, this part being for example intended to be used as interior trim for a motor vehicle.

The invention also relates to the method applied by this device.

### BACKGROUND

A known device of this type comprises a male portion forming a piston and a female portion forming an imprint provided with a molding surface defining granules.

The piston of such a device is mobile relatively to the imprint between a closed position, in which it forms with the imprint a cavity defining the general shape of the part to be made, and an open position in which it is at a distance from the imprint.

During the shaping of the part, a thermoplastic coating intended to form the aspect layer of the part is interposed between the imprint and the piston in the open position of the device, heated and preformed by bringing the imprint closer relatively to the piston.

It should be noted that the face of the coating positioned facing the piston is intended to receive the constitutive plastic material of the supporting layer injected through a conduit passing through the piston.

On the other hand, the face of this coating located facing the imprint is intended to be sucked against the granulated surface of the imprint by means of multitude of conduits passing through this imprint and opening flush with the molding surface of the imprint.

Because of this suction, the part obtained by means of this device has on its aspect layer, circular markings due to the air inlet ports of the suction cannulas, forming aspect defects or imperfections, all the more visible as the decorations of the aspect layer are fine or not very deep.

The invention aims at overcoming this problem.

### SUMMARY OF THE INVENTION

For this purpose, the invention relates to a device for making a multilayer part comprising an aspect layer with a surface in relief, such as grains, formed by a film consisting in a hot malleable and cold stiff material, comprising a piston, an imprint forming with the piston in a closed position a cavity with a shape complementary to the part to be made, the imprint defining a molding surface with a shape complementary to the front face of the aspect layer, against which the film is intended to be hot-shaped and then cooled, sealing means ensuring that the film is pressed against the molding surface of the imprint in a sealable way and ports for sucking the film against the imprint located on the molding surface of this imprint.

According to the invention, the suction ports open out onto a portion of the molding surface of the imprint with a complementary shape to a secondary portion of the aspect layer, such as a peripheral portion of this layer.

According to another feature of the invention, the secondary portion of the aspect layer is a peripheral portion and/or a portion intended to be suppressed from the part to be made.

According to another feature of the invention, the suction ports communicate with suction conduits which comprise tubes which define an internal suction cavity.

According to another feature of the invention, the suction conduits comprise rods with a smaller diameter than the tubes and each are introduced into the cavity of a tube, so as to cross-sectionally define a suction crown.

According to still another feature of the invention, the imprint comprises an added block, an outer surface of which coincides with the molding surface of the imprint and defining with the imprint peripheral play forming the suction port, the suction conduits opening within a gallery provided under the block and communicating with the port for sucking the film.

According to still another feature of the invention, the sealing means comprise a sealing frame framing the film and pressure means ensuring that the frame is pressed against the periphery of the molding surface of the imprint in a sealable way.

According to still another feature of the invention, the piston comprises blowing channels opening at the surface of this piston facing the imprint and intended to blow air against the rear face of the film in order to cool it down.

According to still another feature of the invention, the part to be made comprises a stiff supporting layer formed with a plastic material capable of being shaped by injection molding, the piston comprising a conduit for injecting the plastic material, opening out onto the injection surface of the piston located opposite the imprint.

The invention also relates to the method applied by the device above which comprises a step for hot-positioning the film against the molding surface of the imprint in a sealable way and a step (e) for sucking the air included between the film and the molding surface of the imprint through suction ports localized at the portion of the molding surface of the imprint with a complementary shape to the secondary portion of the aspect layer.

According to still another feature of the invention, the method comprises a step (i) for injecting a constitutive plastic material of the support, against the face of the film opposite to the imprint, this injection step (i) being simultaneous with the suction step through the conduits.

### BRIEF DESCRIPTION OF THE DRAWING FIGURES

The invention will be better understood and other objects, advantages and features of the latter will become apparent upon reading the following description, made with reference to the appended figures wherein:

FIG. 1 is a schematic sectional view of the device according to the invention, during a first step of the method of the invention;

FIG. 2 is an analogous view to that of FIG. 1, during a second step of the method of the invention;

FIG. 3 is a view similar to that of FIG. 1, during a third step of the method of the invention;

FIG. 4 is a schematic sectional view of the imprint of the device of the invention according to another embodiment;

FIG. 5 is a top view of the device of FIG. 4 at the level of the arrow marked as V in this FIG. 4;

FIG. 6 is a top view of the device of FIG. 4 at the level of the arrow marked as VI in this FIG. 4;

FIG. 7 is a cross-sectional view of the device of FIG. 6 along the line marked as VII-VII in this FIG. 6;

FIG. 8 is a cross-sectional view of the device of FIG. 6 along the line marked as VIII-VIII in this FIG. 6;

FIG. 9 is a cross-sectional view of the device of FIG. 2;

FIG. 10 is a top view of the device of FIG. 9 at the level of the arrow marked as X in this FIG. 9;

FIG. 11 is an enlarged view of the area marked as XI in FIG. 9;

FIG. 12 is an enlarged view of the area marked as XII in FIG. 9.

### DETAILED DESCRIPTION

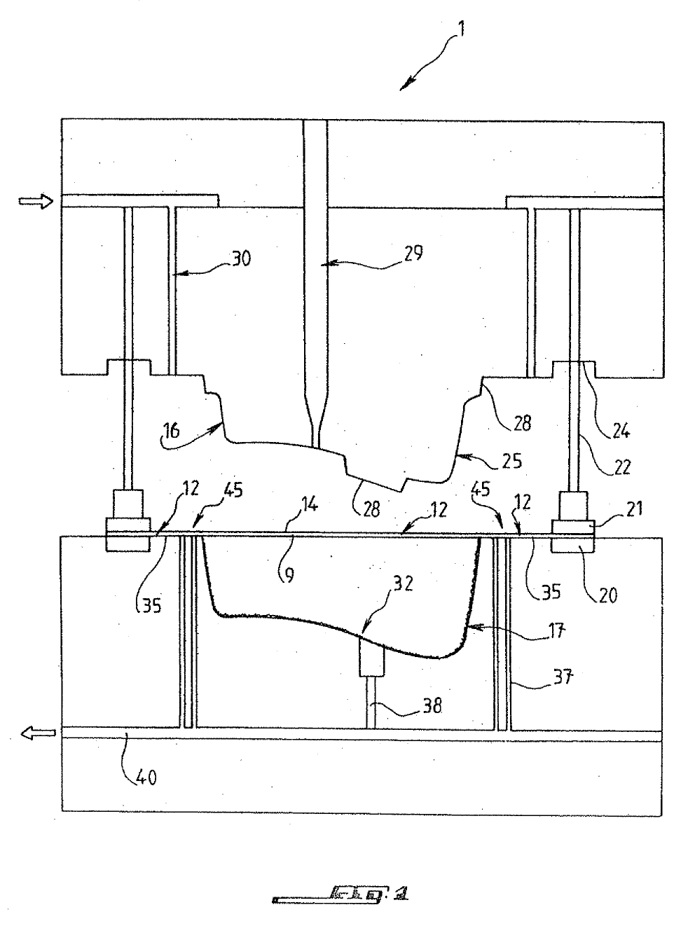

A device 1 for making a multilayer part 2 notably intended to be used as interior trim for a motor vehicle, is illustrated in FIG. 1.

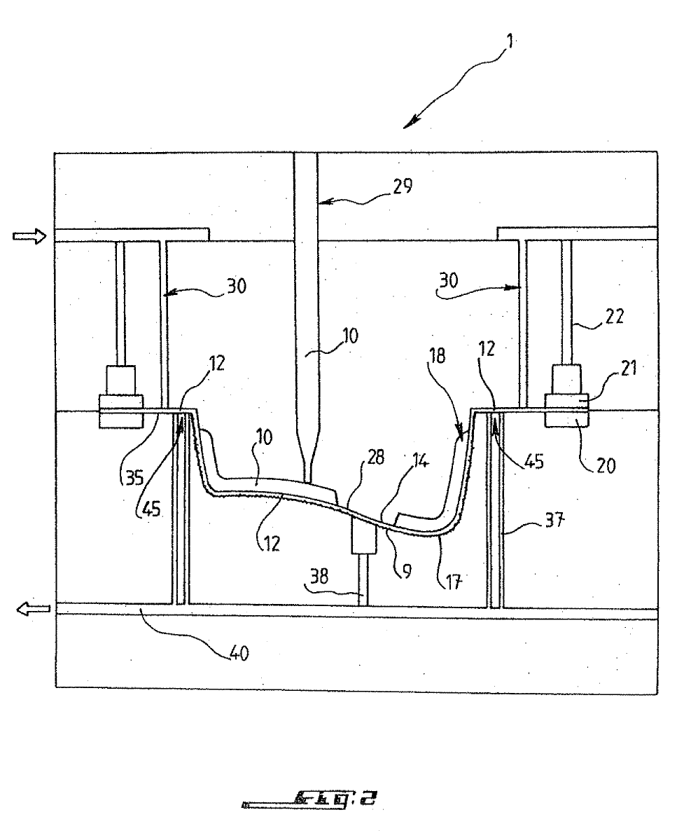

This part 2, better visible in FIG. 3, has a general convex shape defining a main central wall 3, two opposite side walls 4, 5 extending on either side of the central wall 3 and diverging from each other, these three walls 3, 4, 5 defining together a generally U-shaped cross-section and two peripheral walls 7, 8 each extending on one side of a side wall 4, 5 and defining an attachment plane P.

The peripheral walls 7, 8 of the trim part are for example intended for attaching this part to a body portion of the vehicle and to be covered in this case with surrounding parts of this vehicle. According to another possibility, the peripheral walls 7, 8 are detached from the part 2 or reworked by cutting for using the part within the vehicle, and form technical waste. In both cases, when the part is used within the vehicle, the peripheral walls 7, 8 are not apparent or are even reworked by cutting and form for this reason so-called accessory or secondary portions of the part 2.

On the contrary, the side 4, 5 and central 3 walls of the part 2 are intended to be visible to the occupants of the vehicle and have a face coated with grains 9 in the example illustrated in the figures.

Additionally, this part 2 is formed by the assembly of a lower stiff supporting layer 11 made in a plastic material 10 capable of being shaped by injection molding, giving to the part, once it is cooled, the shape and stiffness, and with an upper aspect layer 12 formed by a film forming a coating bearing the face coated with grains and being formed with a thermoplastic material which may be heated, shaped and which retains its shape when it is cooled in its shaped condition, the shape which it had in the hot condition.

This coating film may for example appear as sheets of modified polypropylene, polyvinyl chloride, polyurethane composition.

Advantageously, a layer of foam of the polyolefin or polyurethane type (not shown) forms the rear face of the film 12 and is again found interposed between this film 12 and the support 11 within the part 2.

On the other hand, the supporting layer 11 appears as two distinct portions 11a, 11b, attached on the rear face 14 of the film 12 along the side wall 4 and a portion of the central wall 3 and along the side wall 5 and another portion of the central wall 3, respectively.

As this is better visible in FIG. 3, the aspect layer 12 forms by itself the peripheral walls 7, 8 of the part 2 and forms with the supporting layer 11 the side 4, 5 and central 3 walls of the part 2.

In order to make this part 2, the device according to the invention 1 comprises a mold provided with a male portion forming a piston 16 and with a female portion forming an imprint 17, both mounted on a horizontal and/or vertical injection press.

The piston 16 is translationally mobile relatively to the imprint 17 between a closed position of the mold illustrated in FIG. 2 in which the imprint 17 defines with the piston 16 a cavity 18 with a general complementary shape to the part to be made, and the open position of the mold of FIGS. 1 and 3 allowing the film 12 to be placed and the part to be removed once it is shaped, respectively, as well as a frame 20 and a counter-frame 21 interposed between the imprint 17 and the piston 16 and holding the film 12 between both components.

The frame 20 and the counter-frame 21 have general complementary shapes to the contour of the film 12 and are positioned along the peripheral walls 7, 8 of the film 12 along the front face 9 and the rear face 14 of this film 12, so as to clasp the sides of the film 12.

These frames 20, 21 are mounted mobile relatively to the piston 16, for example by means of an actuator 22 so as to adjust the distance of the film 12 relatively to the imprint 17 and to the piston 16, between a position pressed against the imprint 17, in which the film 12, the imprint 17 and the frames 20, 21 form a sealed assembly, and a remote position relatively to the imprint 17.

Advantageously, this same actuator 22 is a means for ensuring that the frame is held in its pressed position against the imprint. According to another embodiment not shown, these means may be formed with elastic members such as compression springs.

Housings 23 for receiving the frame 20, with a complementary shape to the latter are provided in the bulk of the imprint 17 and secondary housings 24 for receiving the counter-frame 21 with a complementary shape to the latter, are formed within the piston 16.

This piston 16 comprises a protruding portion 25 with a complementary shape to the inner surface 26 of the part to be made 2, defining an injection surface 27, and masks 28 protruding outwards from the injection surface 27 of piston 16 and being of a height so that they may come into contact with the rear face 14 of the film in the closed position of the imprint 17 in order to form the areas of the part 2 without any supporting layer 11.

Injection of plastic material 10 up to the injection surface 27 of the piston 16 is ensured by an injection conduit 29 passing through the piston 16 and opening out onto its injection surface. The pressure of the plastic material injected in the liquid state is between 50 and 250 bars for example.

Additionally, blowing channels 30 also passing through the piston 16 are provided for conveying a gas such as compressed air onto the rear face 14 of the film 12 or onto the foam layer when the film 12 is provided with one, at its peripheral walls 7, 8 in order to cool down this film portion 12 prior to the phase for injecting the constitutive material of the support 11, so that degradation of the film 12 or of the foam because of the temperature of the injected material may thereby be avoided.

On the other hand, the imprint 17 defines a molding surface 32 grained or with reliefs, with a complementary shape to the face coated with grains or the apparent outer surface 33 of the part to be made, visible in FIG. 3, i.e., complementary to the side 4, 5 and central 3 walls of this part. This surface 32 is described as grained because it is scattered with a multitude of grains obtained by technique known per se such as chemical surface treatment, laser or knurling techniques, with which the front face 9 of the heated and then cooled film 12 may be given a grained or granulated aspect.

The imprint 17 also defines a non-grained molding surface 35, substantially planar and with a complementary shape to the outer unapparent surface 34 of the part to be made 2, i.e., complementary to the peripheral walls 7, 8 of this part 2.

This imprint 17 is provided with air suction conduits passing through the imprint 17 and providing a vacuum between the front face 9 of the heated film 12 and the imprint 17, when the frames 20, 21 occupy their position pressed against the imprint 17, so that this face 9 conforms to the grained reliefs of the grained molding surface 32 of the imprint 17.

According to the invention, the conduits 37 are positioned within the imprint 17 so as to suck the accessory portions of the part 2, i.e., for the example of the figures, the portions of the film 12 intended to form peripheral walls 7, 8 of the part. For this purpose, these conduits 37 communicate with a suction port of the film 12 against the imprint 17 located on a portion 45 of the molding surface 32 of the imprint complementary to an accessory portion of the part, i.e., for the example of the FIGURES, the non-grained molding surface 35 of the imprint 17.

These conduits 37 suck in the air with a sufficiently large negative pressure so that the film portions 12 intended to have a granulated aspect are pressed against the molding surface 32 of the imprint and with a sufficiently low negative pressure so as to avoid the formation of deep grains. For example, this negative pressure may attain 800 mbars.

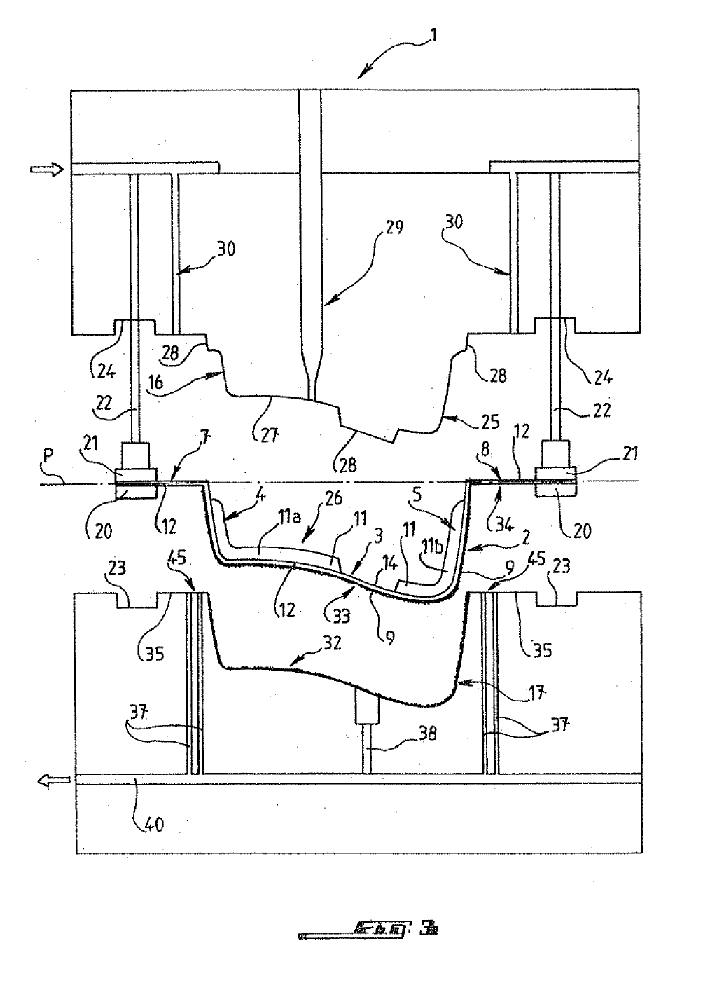

According to a first embodiment of a suction conduit of this type shown in FIG. 5, this conduit 37 forms a cannula or a spindle 38 formed by the assembly of a rod 39 within an internal cavity 41 of a tube 42 with a larger diameter integrated to the imprint 17, defining a suction crown 43.

As visible in FIG. 12, the width of the crown cross-sectionally formed by the spindle may decrease towards the air inlet port so as to form a throttling or venturi element which may locally accelerate suction of air.

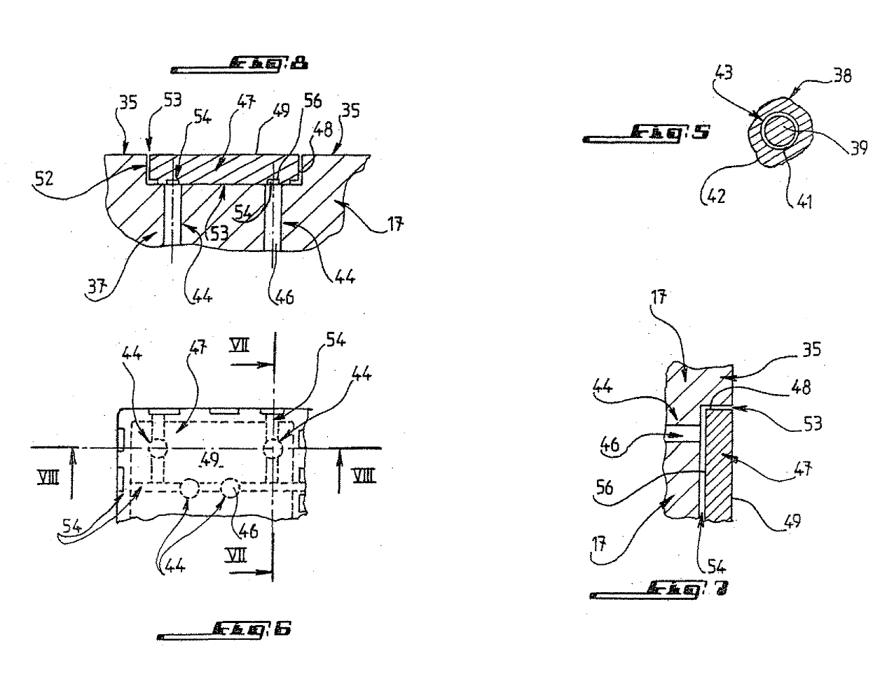

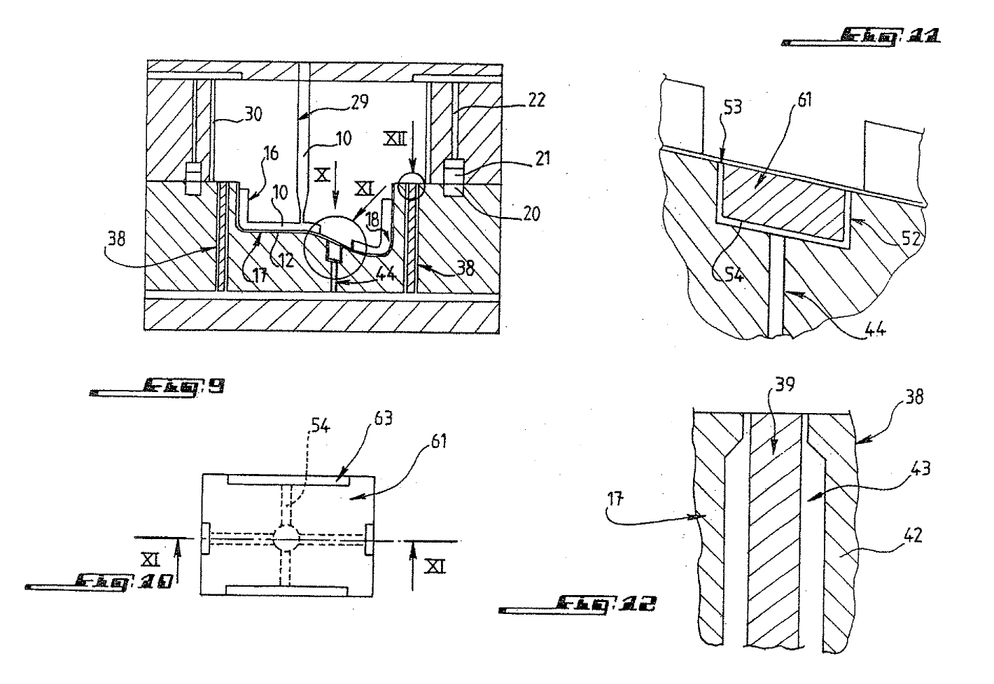

According to another embodiment of these conduits illustrated in FIG. 6, they are formed with tubes 44 defining a substantially circular internal cavity 46. These tubes 44 are designed so as to open out onto the non-grained molding surface 35 of the imprint 17 as illustrated in FIG. 9 or so as to be used for sucking air around a block added to the molding surface 32, 35 of the imprint 17, as illustrated in FIGS. 8 and 11.

Indeed, in a alternative embodiment of the imprint 17, this imprint 17 comprises the added block 47 which appears as a rectangular plate defining three front edges 48, an outer surface 49 either having or not, according to the aspect of the part to be made, reliefs as this is better visible in FIG. 6 to 8.

This block 47 is intended to be inserted in a receiving recess 52 with a complementary shape made from the molding surface 32, 35 of the imprint 17 so that the external surface 49 of the block 47 forms the portion of the molding surface 32, 35 of the imprint 17 which is removed at the recess 52, the block 47 lying on the imprint 17 with base-forming portions 53.

The dimensions of the block 47 and of the recess 52 which receive it are such that there is a peripheral side play 53 between the block 47 and the imprint 17 defining the air suction port.

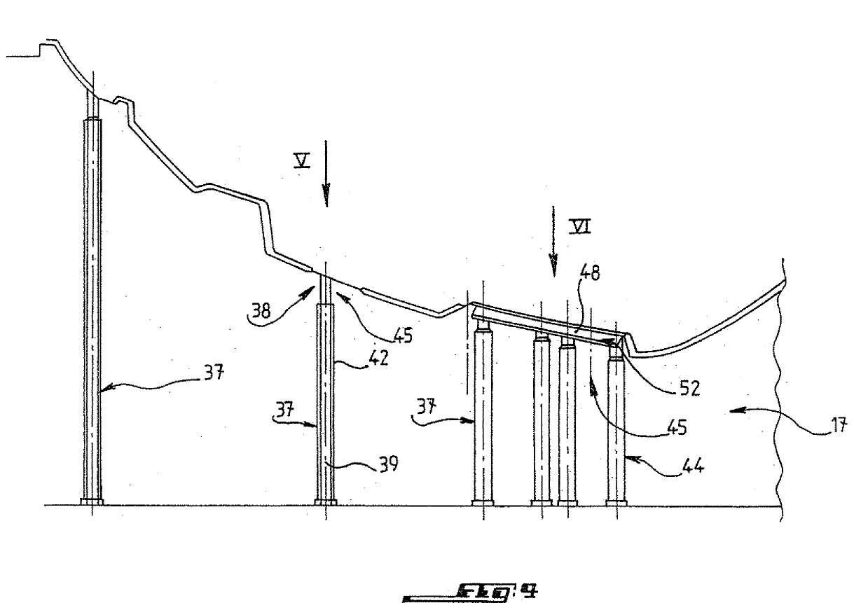

According to this alternative, the block 47 is provided with grooves 54 formed on the lower face of the block 47 located opposite the imprint and defining within the block 47 portions located at a distance 56 from the imprint 17 when the block 47 lies on this imprint 17 and the base-forming portion 53. These grooves advantageously communicate with each other and open out onto the peripheral or front edges 48 of the block 47 as shown in FIG. 7, and thus onto the peripheral suction play 53.

Moreover, according to this same alternative embodiment, the suction conduits 37 open out from the imprint 17 under the block 47 at the grooves 54 provided in this block 47. In this way, with the tubes 44, it is possible to suck from their upper end, the air included between the grooves 54 and the imprint 17 and the air included between the front edges 48 of the block 47 and the corresponding face of the receiving recess 52 of this block 47.

According to still another alternative suction of the film 12 against the imprint illustrated in FIGS. 10 and 11, always located at one portion of the imprint complementary to an accessory portion of the part, suction is provided by means of a block with a larger height and designated hereafter as insert 61, cooperating with a tube 44 of the aforementioned type.

As in the case of the block 47, this insert 61 is housed in a recess 52 provided in the imprint 17 and is laterally spaced apart from this recess 52 by a peripheral play 53. It also contains grooves 54 formed on its face facing the imprint 17, which converge at its centre. The end of the tube 44 opens out from the imprint 17 under the insert 61 at the intersection of the grooves 54 and allows suction of the air included between the grooves 54 and the imprint 17 and between the front edges 48 of the insert 61 and the housing 52 of the latter in order to suck the overlying film 12 against the external face of the insert 61 and the non-grained molding surface 35 of the imprint 17.

It should be noted that cuts 63 may be provided on the contour of the block 47 and/or of the insert 61 in order to increase the surface for sucking the film 12 through the underlying tubes 44 or cannulas 38.

In the aforementioned case of the spindles 38 as in the case of the tubes 44, either associated with the block 47 or not, the air suction ports 40 communicating with these conduits 37 open out on the non-grained molding surface 35 of the imprint 17 with a complementary shape to the peripheral walls of the film 12, which are not visible during the use of the part or are intended to be reworked by cutting.

The suction conduits 37 are advantageously connected to a same suction network 40 formed by pierced channels within the imprint 17. According to a possible alternative, the conduits may be connected to different suction networks so as to control suction independently in time and in intensity.

Moreover, these conduits 37 may also be used once the part is formed in order to blow pressurized air on the front face of this part 2, so as to facilitate removal of this part 2.

In the following, the method applied by the device according to the invention will be described, which comprises:
a step (a) for placing the film (12) intended to form the granulated visible portion of the part to be made 2 and the non-visible peripheral portion of this part, between the frames 20, 21, in the crude condition i.e., flat, this film 12 being possibly provided with a foam layer forming a rear face for this film,
a step (b) for softening this film 12 by heating at a temperature depending on the glass transition temperature of this film 12, this softening temperature may be between 120 and 200° C.,
a step (c) for positioning the assembly formed by the frames 20, 21 and the film against the imprint 17 in a sealable way, by means of actuators 22 for displacing the frames 20, 21, this step may occur prior to the step (b) above,
a step (d) for pre-closing the mold, during which the piston 16 and the imprint 17 are brought closer to each other, the protruding portion 25 of the piston 16 stamping the film, so that there is a mechanical play between the film 12 and the imprint 17 between 0.1 and 1 mm, the frames 20, 21 being also displaced towards their position pressed against the imprint 17, forming with the film 12 and the imprint 17 a sealed assembly,
a step (e) for peripherally sucking the softened film 12 by the suction conduits 37, during which these conduits 37 produce a vacuum between the front face 9 of the film and the molding surface 32 of the imprint, the suction port of these conduits 37 being localized at the accessory portions of the softened film 12, i.e., the peripheral walls. During this step, the film conforms to the reliefs of the imprint and is held against these reliefs by suction of the conduits,
a step (g) for cooling the film 12 by blowing air on the rear face 14 of the film 12 (or on the foam layer if necessary) which may be simultaneous with steps (e) and (f),
a step (h) for completely closing the mold whereby the imprint 17, the film 12 and the piston 16 define the cavities which should be filled with the liquid plastic constitutive material of the support 11,
a step (i) for injecting the constitutive plastic material of the support 11 by means of the injection conduit 28, the injection pressure of this material still participating in the formation of the grains,
a step (j) for cooling the assembly formed by the film 12 and the material of the support 11, whereby the definitive part is obtained,
a step (k) for opening the mold and extracting the part 2.

The device and the method described above provide different advantages, among which:

The air inlet ports of the suction cannulas do not leave any marks on the apparent portions of the part, unlike the known devices.

The possibility of producing fine and not very deep grains on the part to be made, because of the absence of markings of the port of the conduits on the visible portions of the part.

Any sliding of the film during the injection of the thermoplastic is avoided because of the suction by the cannulas during the injection of the thermoplastic, and of the pressure exerted by the frames.

The use of unique tooling for producing the part.

It should be noted that the step of pre closing the mold previously to the step of sucking the film ensures the existence of a mechanical play between the film 12 and the imprint 17 so that the air is sucked over the whole play space between the film 12 and the imprint 17 by sucking ports 40 that are located at the periphery, that is in a non-grained secondary or accessory zone, at the outside of the part 32 of the mold having reliefs, i.e., grained. This avoids the presence of any sucking port in the hollow part 32 that can therefore be grained on its whole surface.

1. A device for making a multilayer part including an aspect layer with a grained surface in a film of a material that is malleable when hot and stiff when cold, the device comprising:
a piston;
an imprint defining a cavity with the piston when the piston is in a closed position, wherein
the cavity has a shape complementary to shape of the part,
the imprint has a molding surface with a shape complementary to the shape of the aspect layer,
sealing means for keeping a secondary non-grained portion of the film against a part of the molding surface while permitting movement of another part of the film with respect to the imprint, and
ports for sucking the film against the imprint, the ports having openings located on the part of the molding surface having a shape complementary to the secondary non-grained portion of the aspect layer.

2. The device according to claim 1, wherein the secondary portion of the aspect layer is a peripheral portion.

3. The device according to claim 1, including suction conduits passing through the imprint, comprising tubes defining an internal suction cavity and communicating with the suction ports.

4. The device according to claim 3, wherein the suction conduits comprise rods with a smaller diameter than the tubes, each rod being introduced into a tube to cross-sectionally define a suction crown.

5. The device according to claim 1, wherein the imprint comprises an added block having an outer surface which coincides with the molding surface of the imprint, and defining, with the imprint, a peripheral play of the suction port, the suction conduits opening within a gallery located under the added block and communicating with the suction port.

6. The device according to claim 1, wherein the sealing means comprises a sealing frame framing the film and pressure means ensuring that the frame is pressed against a periphery of the molding surface of the imprint.

7. The device according to claim 1, wherein the piston comprises blowing channels opening at the surface of the piston that faces the imprint, for blowing air against the film to cool the film.

8. The device according to claim 1, wherein the piston comprises a conduit for injecting plastic material and opening on an injection surface of the piston, facing the imprint.

9-11. (canceled)

12. A method of manufacturing a multilayer part including an aspect layer having a grained surface, the method comprising:
positioning a hot film opposite an imprint having a molding surface with the shape of the part;
evacuating air from between the film and the molding surface through suction ports located in the molding surface at a secondary non-grained portion of the, aspect layer and
forming the film by pressing the film against the molding surface with a piston having a shape complementary to the imprint.

13. The method of claim 12 including, simultaneously with evacuating, injecting a plastic support material onto the film, with the film between the plastic material and the molding surface.

14. The method of claim 12 including, before evacuation, stamping the film with the piston against the molding surface.
